(19) United States
(12) Patent Application Publication
(10) Pub. No.: US 2026/0326401 A1
(43) Pub. Date: Oct. 22, 2026

(54) BAND-FORMING DRUM AND CONTROL SYSTEM THEREOF

(71) Applicant: Toyo Tire Corporation, Itami-shi (JP)

(72) Inventor: Kazuya Washio, Itami-shi (JP)

(73) Assignee: Toyo Tire Corporation, Itami-shi (JP)

(21) Appl. No.: 19/646,759

(22) Filed: Apr. 14, 2026

(30) Foreign Application Priority Data
Apr. 18, 2025 (JP) 2025-068564

(51) Int. Cl. B29D 30/26; F15B 11/16; F15B 13/07

(52) U.S. Cl. CPC B29D 30/26; F15B 11/16; F15B 13/07; B29D 2030/2685

(57) ABSTRACT

A band-forming drum includes a first segment connected to each of a plurality of first air cylinders arrayed in the circumferential direction, and a second segment connected to each of a plurality of second air cylinders arrayed in the circumferential direction. The plurality of first air cylinders each have a first movable portion movable in the radial direction. The plurality of second air cylinders each have a second movable portion movable in the radial direction in a position different from each of the first air cylinders in the circumferential direction. The plurality of the first segments and the plurality of the second segments are in a same radial position and each of the plurality of first segments and each of the plurality of second segments are adjacent to each other with a gap interposed between the first segment and the second segment in the circumferential direction.

### PRIORITY INFORMATION

The entire disclosure of Japanese Patent Application No. 2025-068564 filed on Apr. 18, 2025 including the specification, claims, drawings, and abstract is incorporated herein by reference in its entirety.

### BACKGROUND

### Technical Field

The present invention relates to a band-forming drum and a control system thereof.

### Related Art

In JP 2003-89158 A, a band-forming drum that forms a cylindrical band on an outer peripheral surface thereof is disclosed. The band-forming drum includes a plurality of segments and drive means. The plurality of segments are arrayed in the circumferential direction and are movable in the radial direction. A band component forming the band is wrapped around outer peripheral surfaces of the plurality of segments. The drive means is for expanding and reducing the diameter of each segment in the radial direction.

In the band-forming drum disclosed in JP 2003-89158 A, switching is only performed between a state in which each segment is spread out in the radial direction and a state in which each segment is reduced in diameter in the radial direction. Therefore, when each segment is moved to a diameter-reduced state, there is a possibility that some segments may not come off from the cylindrical band and may remain in close contact. As a result, there is room for improvement in terms of releasability of a band member from each segment. In the configuration described above, tapered surfaces of tapered cones and inclined surfaces of the segment are brought into contact with each other via a linear guide, and the segment is pushed out in the radial direction by the movement of the tapered cones in the axial direction. Therefore, there is room for improvement in terms of smoothly moving each segment in the radial direction and facilitating improvement in the durability of parts.

### SUMMARY

A first band-forming drum according to the present invention is a band-forming configured to form a cylindrical band on an outer peripheral surface and includes: a first segment connected to each of a plurality of first air cylinders arrayed in a circumferential direction, and a second segment connected to each of a plurality of second air cylinders arrayed in the circumferential direction The plurality of first air cylinders each having a first movable portion movable in a radial direction. The plurality of second air cylinders each having a second movable portion movable in the radial direction at a position different from each of the first air cylinders in the circumferential direction. In the band-forming drum, a plurality of the first segments and a plurality of the second segments are alternately disposed in the circumferential direction such that the plurality of first segments and the plurality of second segments are in a same radial position and each of the plurality of first segments and each of the plurality of second segments are adjacent to each other with a gap interposed between the first segment and the second segment in the circumferential direction in a fully open state in which each of the plurality of first segments and the plurality of second segments are expanded in diameter.

A second band-forming drum according to the present invention is a band-forming drum configured to form a cylindrical band on an outer peripheral surface and includes: a first segment connected to each of a plurality of first air cylinders arrayed in a circumferential direction; and a second segment connected to each of a plurality of second air cylinders arrayed in the circumferential direction. The plurality of first air cylinders each have a first movable portion movable in a radial direction. The plurality of second air cylinders each have a second movable portion movable in the radial direction at a position different from each of the first air cylinders in the circumferential direction. In the band-forming drum, a plurality of the first segments and a plurality of the second segments do not face each other in the radial direction in a fully open state in which each of the plurality of first segments and the plurality of second segments is expanded in diameter.

A control system of a band-forming drum according to the present invention includes the band-forming drum according to the present invention, and a control apparatus. In the band-forming drum, there are provided one first air supply control valve configured to control supply of air for the plurality of first air cylinders and one second air supply control valve configured to control supply of air for the plurality of second air cylinders. The control apparatus is configured to control the first air supply control valve and the second air supply control valve.

According to the band-forming drum and the control system thereof according to the present invention, it becomes possible to improve the releasability of the band member from each segment and move each segment in the radial direction more smoothly, and the durability of the parts is easily improved.

### BRIEF DESCRIPTION OF THE DRAWINGS

Embodiment(s) of the present disclosure will be described by reference to the following figures, wherein:

FIG. 1 is a view showing a diameter-expanded state of all segments of a band-forming drum of an embodiment in a longitudinal section in a control system of the band-forming drum;

FIG. 2 is a view of the band-forming drum in the state of FIG. 1 seen from the distal end side;

FIG. 3 is a longitudinal sectional view showing a diameter-reduced state of all the segments of the band-forming drum in FIG. 1;

FIG. 4 is a view of the band-forming drum in the state of FIG. 3 seen from the distal end side;

FIG. 5 is a sectional view taken along line A-A in FIG. 1 and is a view showing a state in which a plurality of first segments are reduced in diameter and a plurality of second segments are expanded in diameter;

FIG. 6 is a sectional view taken along line A-A in FIG. 1 and is a view showing a state in which the plurality of first segments are expanded in diameter and the plurality of second segments are reduced in diameter;

FIG. 7 is a longitudinal sectional view showing a diameter-expanded state of all segments of a band-forming drum of a comparative example;

FIG. 8 is a sectional view taken along line B-B in FIG. 7 and a view showing a diameter-expanded state of all the segments on the left half and a diameter-reduced state of all the segments on the right half;

FIG. 9 is a longitudinal sectional view showing a diameter-expanded state of all segments in a band-forming drum of another example of the embodiment; and

FIG. 10 is a view of the band-forming drum in FIG. 9 seen from the distal end side.

### DESCRIPTION OF EXEMPLARY EMBODIMENTS

One example of an embodiment of a band-forming drum according to the present invention is described in detail below with reference to the drawings. The embodiment described below is merely an example, and the present invention is not limited to the embodiment below.

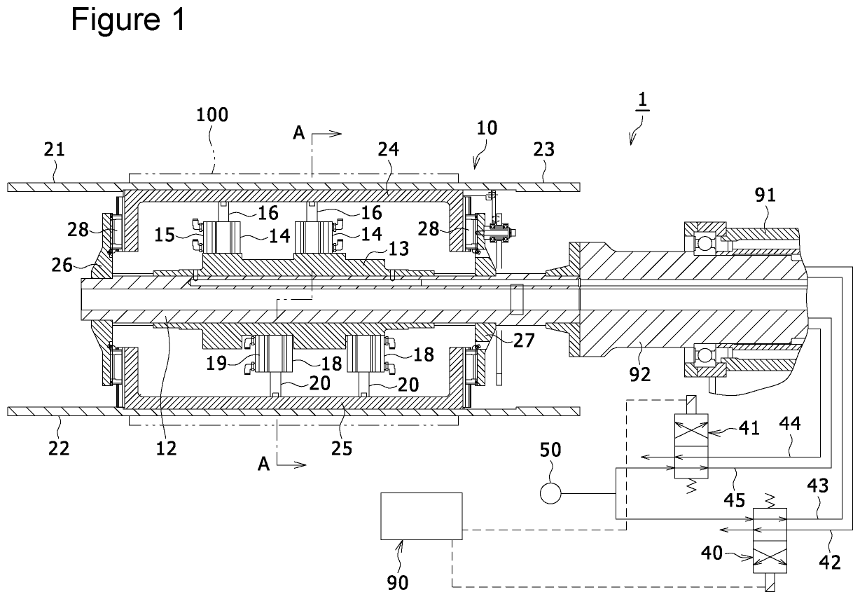

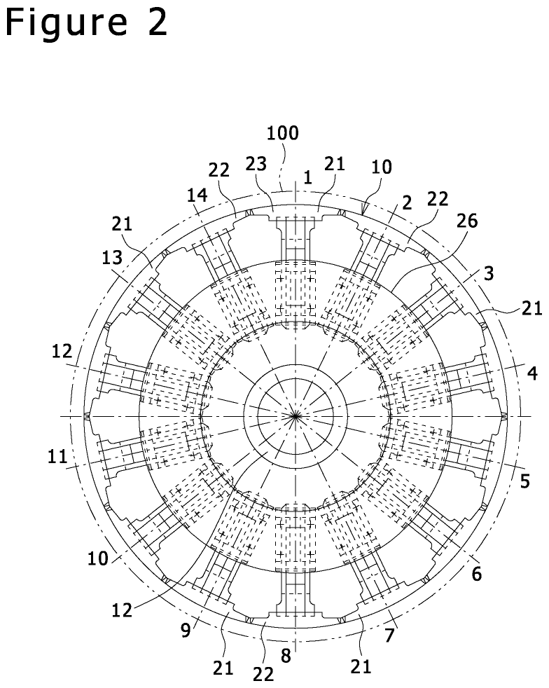

FIG. 1 is a view showing a diameter-expanded state of all segments of a band-forming drum 10 of the embodiment in a longitudinal section in a control system 1 of the band-forming drum. FIG. 2 is a view of the band-forming drum 10 in the state of FIG. 1 seen from the distal end side. The band-forming drum 10 of the present embodiment has a function of forming a cylindrical band 100 such as a carcass band on an outer peripheral surface of the band-forming drum 10 as a result of a strip-shaped or sheet-shaped band component such as a carcass ply that is a reinforcing member including an inner liner and cord formed by a rubber material being wrapped around the outer peripheral surface to be at least partially laminated in a tire-building step. The cylindrical band 100 may be a belt band or the like.

The cylindrical band 100 is built in a state in which the band-forming drum 10 is expanded in diameter, and then the band 100 is sucked and held by a plurality of suction portions configuring a transfer apparatus (not shown) from the outer peripheral side of the band 100. Subsequently, the band-forming drum 10 is reduced in diameter and is moved in the axial direction. Then, the band 100 is sent to the next step by the transfer apparatus. By repeating the above, a large number of the bands 100 can be sequentially built and sent to the next step.

The control system 1 of the band-forming drum includes the band-forming drum 10 and a control apparatus 90. The band-forming drum 10 is configured by including a rotatable drum shaft 12, a plurality of first air cylinders 14 and a plurality of second air cylinders 18, and a plurality of first segments 21 and a plurality of second segments 22. The plurality of first air cylinders 14 have a plurality of first cylinder portions 15, and a plurality of first movable portions 16. The plurality of second air cylinders 18 have a plurality of second cylinder portions 19 and a plurality of second movable portions 20.

The plurality of first cylinder portions 15 each have a block shape. The plurality of first cylinder portions 15 are arrayed in the circumferential direction at two positions spaced apart from each other in the axial direction of a tubular sleeve 13 fixed to the drum shaft 12 so as to extend in the radial direction of the band-forming drum 10, and a cylinder bore extending in the radial direction is formed on the inner side of each of the first cylinder portions 15. The plurality of second cylinder portions 19 each have a block shape. The plurality of second cylinder portions 19 are arrayed in the circumferential direction at two positions spaced apart from each other in the axial direction of the sleeve 13 so as to extend in the radial direction of the band-forming drum 10, and a cylinder bore extending in the radial direction is formed on the inner side of each of the second cylinder portions 19. The positions of the first air cylinders 14 and the second air cylinders 18 in the axial direction of the drum shaft 12 are different from each other, and the first air cylinders 14 and the second air cylinders 18 are alternately disposed in the axial direction.

The plurality of first movable portions 16 are piston portions. One first movable portion 16 is provided in a corresponding one of the first cylinder portions 15 in a slidable manner. The plurality of second movable portions 20 are piston portions. One second movable portion 20 is provided in a corresponding one of the second cylinder portions 19 in a slidable manner.

The first segments 21 are fixed to distal ends of the first movable portions 16 disposed at a plurality of positions in the circumferential direction radially outward of the drum shaft 12, via first joining members 24 each having a substantially U-shaped section. The first segments 21 each have a plate-like shape with an arc-shaped section long in the axial direction of the drum shaft 12, and an outer periphery thereof is a curved surface with a substantially arc-shaped section. The first segment 21 is fixed onto a distal end surface of the first joining member 24 by screw joining and the like.

The second segments 22 are fixed to distal ends of the second movable portions 20 disposed at a plurality of positions in the circumferential direction radially outward of the drum shaft 12 via second joining members 25 each having a substantially U-shaped section. The second segments 22 each have a plate-like shape long in the axial direction of the drum shaft 12, and an outer periphery thereof is a curved surface with a substantially arc-shaped section. The second segment 22 is fixed onto a distal end surface of the second joining member 25 by screw joining and the like.

Two first air cylinders 14 spaced apart from each other in the axial direction of the band-forming drum 10 are connected to each of the plurality of first segments 21 as the first air cylinders 14. Two second air cylinders 18 spaced apart from each other in the axial direction of the band-forming drum 10 are connected to each of the plurality of second segments 22 as the second air cylinders 18. As a result, it becomes easy to hold each of the segments 21, 22 in the diameter-expanded state even when an external force in a direction of reducing the diameter is applied to a drum main body 23 configured by the plurality of segments 21, 22 in the diameter-expanded state. Therefore, the cylindrical band 100 with a predetermined inner diameter is easily built.

Therefore, each of the plurality of first segments 21 is connected to the plurality of first air cylinders 14, and each of the plurality of second segments 22 is connected to the plurality of second air cylinders 18. Each of the plurality of first movable portions 16 is movable in the radial direction of the band-forming drum 10. Each of the plurality of second movable portions 20 is movable in the radial direction of the band-forming drum 10 in positions different from the plurality of first air cylinders 14 in the circumferential direction. The expansion in diameter or reduction in diameter of the plurality of first segments 21 can be executed by switching air intake and exhaust on both sides of piston portions of the first movable portions 16 of the plurality of first air cylinders 14. The expansion in diameter or reduction in diameter of the plurality of second segments 22 can be executed by switching air intake and exhaust on both sides of piston portions of the second movable portions 20 of the plurality of second air cylinders 18. The air intake and exhaust of the plurality of first air cylinders 14 and the plurality of second air cylinders 18 are controlled by the control apparatus 90 via a first air supply control valve 40 and a second air supply control valve 41 described later.

As shown in FIG. 2, in this example, the plurality of first segments 21 are seven first segments 21, and the plurality of second segments 22 are seven second segments 22. As a result, the cylindrical drum main body 23 configured by the plurality of first segments 21 and the plurality of second segments 22 expanded in diameter is divided into 14 parts in the circumferential direction, and is configured by seven first segments 21 and seven second segments 22 alternately disposed in the circumferential direction. Therefore, as compared to a configuration in which the drum main body is configured by fewer than 14 segments, the length of each of the segments 21, 22 in the circumferential direction can be reduced. As a result, the drum main body 23 is removed more easily from the cylindrical band 100 disposed on the outer periphery by the change of each of the segments 21, 22 to the diameter-reduced state.

As shown in FIG. 2, in a fully open state in which the plurality of first segments 21 and the plurality of second segments 22 are expanded in diameter, the plurality of first segments 21 and the plurality of second segments 22 do not face each other in the radial direction. In the fully open state shown in FIG. 2, the plurality of first segments 21 and the plurality of second segments 22 are arranged in the circumferential direction in the same radial positions in the band-forming drum 10 in a state of being arranged alternately disposed one by one in the circumferential direction. In this state, a gap in the circumferential direction that is equal to or less than 1.0 mm, for example, 0.7 mm, is provided between the first segment 21 and the second segment 22 adjacent to each other.

In FIG. 2, the uppermost first segment 21 is denoted by a number “1” on the outer peripheral side thereof. After the above, the plurality of segments arranged in the clockwise direction in FIG. 2 are denoted by numbers “2”, “3” . . . on the outer peripheral side thereof. Therefore, segments denoted by odd numbers 1, 3, 5 . . . on the outer peripheral side thereof are the first segments 21, and segments denoted by even numbers 2, 4, 6 . . . on the outer peripheral side thereof are the second segments 22. FIG. 2 shows a case in which seven first segments 21 and seven second segments 22, that is, a total of 14 segments, are arranged in the circumferential direction. The number of each of the segments is not limited to the above and can be any number, such as five, six, or eight. The first segments 21 and the second segments 22 are preferably equal in number.

Annular members 26, 27 are fixed to the outer periphery of the drum shaft 12 at two positions spaced apart from each other in the axial direction of the drum shaft 12 so as to extend in the radial direction. Linear guide apparatuses 28 that respectively restrict the movement of the joining members 24, 25 in the radial direction are provided between the annular members 26, 27 and axial-direction outer surfaces of the joining members 24, 25. The linear guide apparatus 28 enables smooth movement of the joining members 24, 25 in the radial direction by using the rolling of a plurality of balls, for example.

Although illustration is omitted, at least one of the plurality of first segments 21 and the plurality of second segments 22 may be supported at a plurality of positions in the circumferential direction of a support ring rotatably supported by the drum shaft 12 via a respective link for each of the at least one of the plurality of first segments 21 and the plurality of second segments 22.

The width of each of the first segments 21 and the width of each of the second segments 22 corresponding to the axial direction of the band-forming drum 10 are the same. On a proximal end portion (a right end portion in FIG. 1) of the drum shaft 12, a main shaft 92 rotatably driven by a rotary drive unit such as a motor is fixed to a fixing portion 91 by being fastened by bolt fastening means and the like.

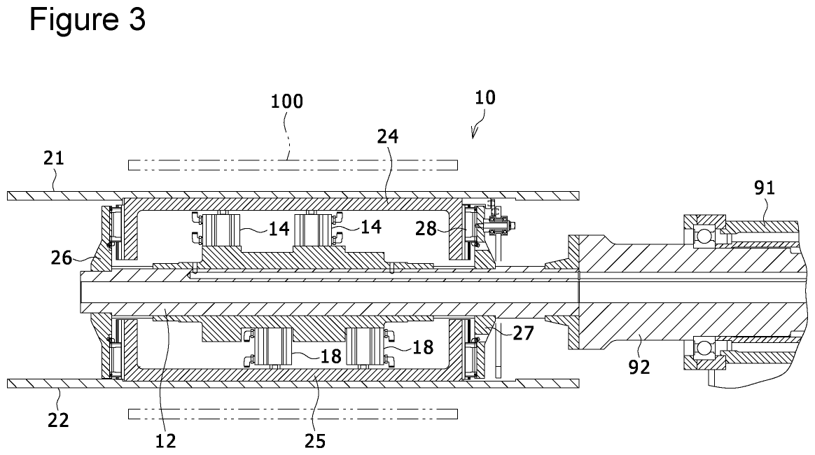

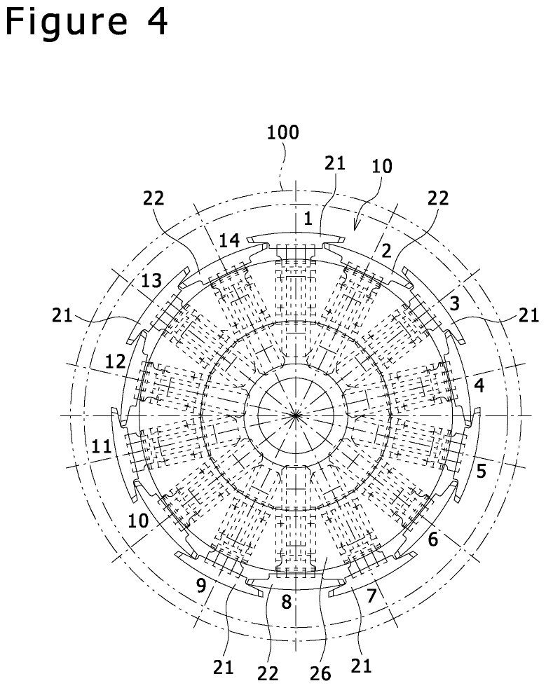

FIG. 3 is a longitudinal sectional view showing a diameter-reduced state of all the segments of the band-forming drum 10. FIG. 4 is a view of the band-forming drum 10 in the state of FIG. 3 seen from the distal end side. As shown in FIG. 3 and FIG. 4, in a fully closed state in which the plurality of first segments 21 and the plurality of second segments 22 are reduced in diameter, outer peripheral side surfaces of each of the segments 21, 22 are separated from the band 100. The band 100 can be removed by sucking and holding surfaces of the plurality of segments 21, 22 on the outer peripheral side thereof in advance by a plurality of suction members configuring the transfer apparatus before the fully closed state is reached and moving the band-forming drum 10 in the axial direction.

The stroke of the plurality of second air cylinders 18 in the radial direction of the band-forming drum 10 is longer than the stroke of the plurality of first air cylinders 14 in the radial direction of the band-forming drum 10. For example, the stroke of the plurality of second air cylinders 18 in the radial direction of the band-forming drum 10 can be longer than the stroke of the plurality of first air cylinders 14 in the radial direction of the band-forming drum 10 by about 10 mm. For example, the stroke of the second air cylinders 18 can be 40 mm, and the stroke of the first air cylinders 14 can be 30 mm. As a result, in the fully closed state shown in FIG. 4, circumferential-direction end portions of the plurality of first segments 21 can be disposed on the radial-direction outer side of circumferential-direction end portions of the plurality of second segments 22 to be brought close thereto. In this state, a gap in the radial direction can be provided between the circumferential-direction end portion of the second segment 22 and the circumferential-direction end portion of the first segment 21.

As shown in FIG. 1, one first air supply control valve 40 and one second air supply control valve 41 are provided for the band-forming drum 10. The first air supply control valve 40 controls the supply of air for the plurality of first air cylinders 14. The second air supply control valve 41 controls the supply of air for the plurality of second air cylinders 18. The first air supply control valve 40 and the second air supply control valve 41 are controlled by the control apparatus 90.

Specifically, a first diameter-expansion air supply passage 42 and a first diameter-reduction air supply passage 43 are connected to two air chambers existing on both surfaces of the piston portion of each first air cylinder 14. The first diameter-expansion air supply passage 42 and the first diameter-reduction air supply passage 43 are connected to an air supply source 50 configured by a blower, a compressed air tank, and the like via the first air supply control valve 40, which is a solenoid valve. The first air supply control valve 40 is configured to be switchable between a state in which the air supply source 50 and the first diameter-expansion air supply passage 42 are connected to each other and the air in the first diameter-reduction air supply passage 43 is exhausted to the outside, and a state in which the air supply source 50 and the first diameter-reduction air supply passage 43 are connected to each other and the air in the first diameter-expansion air supply passage 42 is exhausted to the outside by the control of the control apparatus 90.

Meanwhile, a second diameter-expansion air supply passage 44 and a second diameter-reduction air supply passage 45 are connected to two air chambers existing on both surfaces of the piston portion of each second air cylinder 18. The second diameter-expansion air supply passage 44 and the second diameter-reduction air supply passage 45 are connected to the air supply source 50 configured via the second air supply control valve 41, which is a solenoid valve. The second air supply control valve 41 is configured to be switchable between a state in which the air supply source 50 and the second diameter-expansion air supply passage 44 are connected to each other and the air in the second diameter-reduction air supply passage 45 is exhausted to the outside, and a state in which the air supply source 50 and the second diameter-reduction air supply passage 45 are connected to each other and the air in the second diameter-expansion air supply passage 44 is exhausted to the outside by the control of the control apparatus 90.

As a result, switching is performed between the extension of a protruding part of a rod, which is connected to the piston portion, from a cylinder corresponding to the diameter expansion of the first air cylinder 14 and the reduction of the protruding part of the rod corresponding to the diameter reduction of the first air cylinder 14. Similarly, switching is performed between the extension of a protruding part of a rod, which is connected to the piston portion, from a cylinder corresponding to the diameter expansion of the second air cylinder 18 and the reduction of the protruding part of the rod corresponding to the diameter reduction of the second air cylinder 18.

The control apparatus 90 is configured by a microcomputer having an operator such as a CPU and a storage device such as a memory, for example. The control apparatus 90 controls the first air supply control valve 40 and the second air supply control valve 41 so as to place the plurality of first segments 21 and the plurality of second segments 22 in a fully open state in which the plurality of first segments 21 and the plurality of second segments 22 are in a diameter-expanded state and then change the plurality of second segments 22 to a diameter-reduced state while maintaining the plurality of first segments 21 in a diameter-expanded state, return the plurality of first segments 21 and the plurality of second segments 22 to a diameter-expanded state and then change the plurality of first segments 21 to a diameter-reduced state while maintaining the plurality of second segments 22 in a diameter-expanded state, and change the plurality of first segments 21 and the plurality of second segments 22 to a diameter-reduced state.

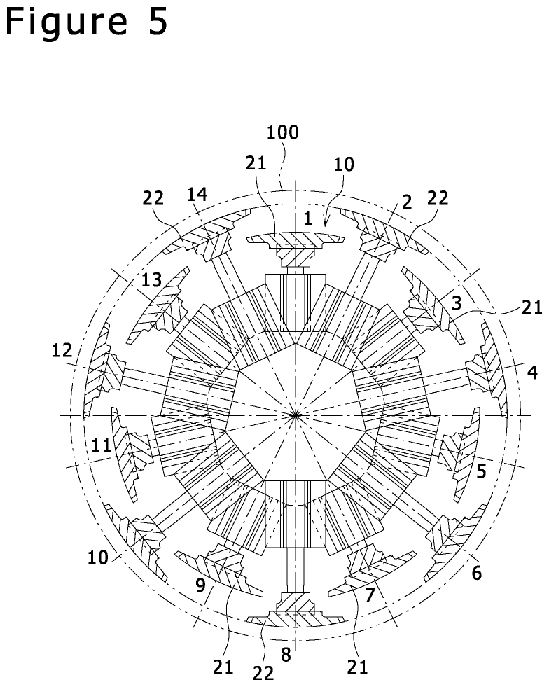

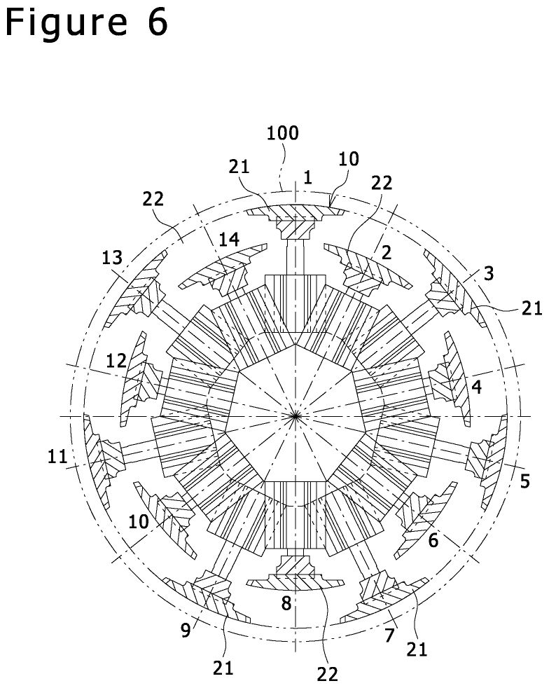

FIG. 5 is a sectional view taken along line A-A in FIG. 1 and is a view showing a state in which the plurality of first segments 21 are reduced in diameter and the plurality of second segments 22 are expanded in diameter. FIG. 6 is a sectional view taken along line A-A in FIG. 1 and is a view showing a state in which the plurality of first segments 21 are expanded in diameter and the plurality of second segments 22 are reduced in diameter.

When the cylindrical band 100 is built with use of the band-forming drum 10, first, as shown in FIG. 1 and FIG. 2, the control apparatus 90 holds the plurality of first segments 21 and the plurality of second segments 22 in a fully open state in which the plurality of first segments 21 and the plurality of second segments 22 are in a diameter-expanded state in accordance with an operation of a user using an operating portion (not shown) or the end of a previous band-forming step; in other words, the band 100 built in the previous band-forming step being transferred to the next step by the transfer apparatus. In this state, the band-forming drum 10 forms the drum main body 23 substantially having an identical circular outer peripheral surface, and holds the state. In this state, a plurality of band components that are strip-shaped or sheet-shaped, for example, are wrapped around the outer peripheral surface of the drum main body 23 so as to be at least partially laminated while the drum shaft 12 is rotated by the rotary drive unit. As a result, the cylindrical band 100 having a predetermined inner diameter is formed. The step of forming the band 100 as above can be performed by a band-forming apparatus, for example (not shown).

Next, a step of separating the cylindrical band 100 that removes the band 100 from the band-forming drum 10 is performed. Specifically, in the step of separating the band 100, for example, the band 100 is sucked and held by the plurality of suction portions configuring the transfer apparatus from the outer peripheral side of the band 100. Then, the control apparatus 90 reduces the plurality of second segments 22 in diameter as shown in FIG. 6 by the control of the second air supply control valve 41. At this time, the plurality of first segments 21 are placed in a first state by being held while maintaining a diameter-expanded state, and support the band 100 from the inner side of the plurality of first segments 21. As a result, the plurality of second segments 22 can be easily detached from the inner peripheral surface of the band 100.

Next, the control apparatus 90 causes the plurality of second segments 22 to expand in diameter by the operation of the plurality of second air cylinders 18 by the control of the second air supply control valve 41, and temporarily returns the state to the fully open state shown in FIG. 1 and FIG. 2. Then, as shown in FIG. 5, the control apparatus 90 reduces the plurality of first segments 21 in diameter by the operation of the plurality of first air cylinders 14 by the control of the first air supply control valve 40. At this time, the plurality of second segments 22 are placed in a second state by being held while maintaining a diameter-expanded state, and support the band 100 from the inner side of the plurality of second segments 22. As a result, the plurality of first segments 21 can be easily detached from the inner peripheral surface of the band 100.

Then, the control apparatus 90 obtains a fully closed state in FIG. 3 and FIG. 4 by reducing the plurality of second segments 22 in diameter and then reducing the plurality of first segments 21 in diameter by the control of the first air supply control valve 40 and the second air supply control valve 41. As a result, in this example, the band 100 can be transferred to the next step by the transfer apparatus after the first state and the second state are alternately realized and the cylindrical band 100 is separated from the band-forming drum 10.

According to the band-forming drum 10 and the control system 1 thereof described above, the first state and the second state can be alternately realized, and hence the releasability of the band 100 from each of the segments 21, 22 can be improved, unlike a configuration allowing performance of only switching between two states, that is, the fully open state and the fully closed state of the plurality of segments 21, 22. Further, the first segments 21 connected to the plurality of first air cylinders 14 arrayed in the circumferential direction and the second segments 22 connected to the plurality of second air cylinders 18 arrayed in the circumferential direction are included. The plurality of first air cylinders 14 each have the first movable portion 16 movable in the radial direction of the band-forming drum 10, and the plurality of second air cylinders 18 each have the second movable portion 20 movable in the radial direction of the band-forming drum 10. As a result, it is possible for the movement of the drive unit for reducing the diameter of each of the segments 21, 22 to be only the movement of the air cylinders 14, 18 along the moving directions of the segments 21, 22. Regarding the air cylinders 14, 18 that are the drive units, structures that are small in size can be disposed in a distributed manner. Therefore, each of sliding portions can be made small, and the force for causing the sliding portions to slide can be made small. As a result, each of the segments 21, 22 can be moved in the radial direction more smoothly and the durability of the parts is easily improved.

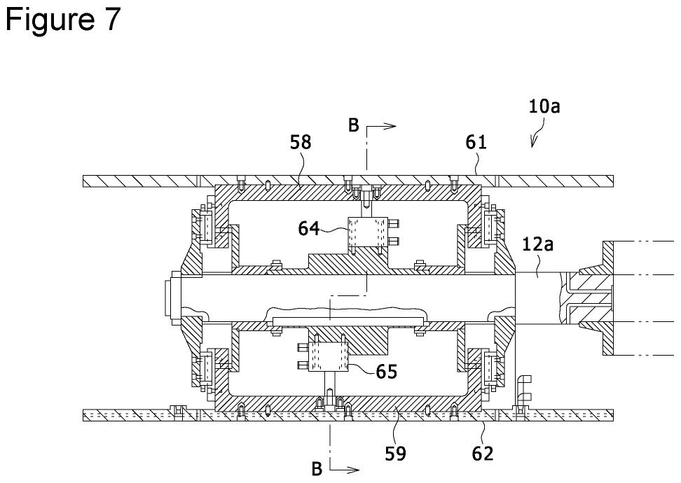

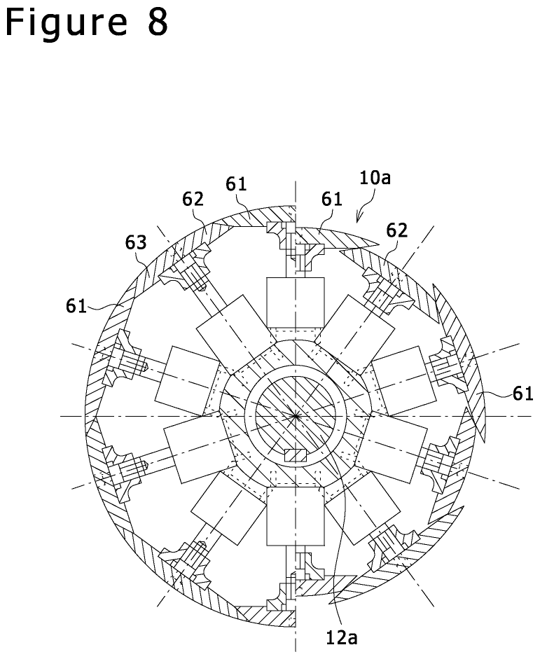

FIG. 7 is a longitudinal sectional view showing a diameter-expanded state of all segments of a band-forming drum 10a of a comparative example. FIG. 8 is a sectional view taken along line B-B in FIG. 7 and a view showing a diameter-expanded state of all the segments on the left half and a diameter-reduced state of all the segments on the right half.

In the band-forming drum 10a of the comparative example, joining members 58, 59 movable in the radial direction are provided at a plurality of positions in the circumferential direction on the outer peripheral side of a drum shaft 12a, and first segments 61 and second segments 62 fixed to the joining members 58, 59 are alternately disposed in the circumferential direction. As a result, each of the segments 61, 62 is configured to be movable in the radial direction of the band-forming drum 10. The joining member 58 to which the first segment 61 is fixed is switched between diameter expansion and diameter reduction by a first air cylinder 64. The joining member 59 to which the second segment 62 is fixed is switched between diameter expansion and diameter reduction by a second air cylinder 65. The supply of air for each of the air cylinders 64, 65 is controlled by a control apparatus (not shown) via an air supply control valve (not shown).

Meanwhile, as shown in the left half part of FIG. 8, in a fully open state in which each of the segments 61, 62 is expanded in diameter, the following state is obtained. On the radial-direction inner side of a circumferential-direction end portion of the first segment 61, a circumferential-direction end portion of the second segment 62 adjacent to the first segment 61 in the circumferential direction faces the circumferential-direction end portion of the first segment 61 in the radial direction in an overlapping manner. In the comparative example, as shown in the right half part of FIG. 8, the second segments 62 realize a fully closed state reduced in diameter earlier than the first segments 61. Meanwhile, in the comparative example, unlike the embodiment in FIG. 1 to FIG. 6, a state in which the first segments are reduced in diameter cannot be realized in a state in which the second segments are expanded in diameter. Therefore, in the comparative example, there is performed switching between only two states, that is, the fully open state in the left half part of FIG. 8 and the fully closed state in the right half part of FIG. 8.

In the comparative example, only a total of ten segments 61, 62, that is, five first segments 61 and five second segments 62, are provided. Therefore, when the outer diameter of a drum main body 63 formed by outer peripheral portions of each of the segments 61, 62 when the band-forming drum 10 of the comparative example is fully open is the same as the outer diameter of the drum main body 23 of the band-forming drum 10 of the embodiment in FIG. 1 to FIG. 6 when fully open, the length of each of the segments 61, 62 of the comparative example in the circumferential direction becomes greater than the length of each of the segments 21, 22 of the embodiment in the circumferential direction. Therefore, in the comparative example, the close contact area between a cylindrical band formed on an outer peripheral surface of the drum main body 63 and each of the segments 61, 62 becomes large, and hence there is room for improvement in the releasability of each of the segments 61, 62 from the band.

In the comparative example, a state in which one of the first segments 61 and the second segments 62 is expanded in diameter and the other is reduced in diameter and a state in which one is reduced in diameter and the other is expanded in diameter cannot be alternately realized, and hence there is room for improvement in releasability from this point as well. In the embodiment in FIG. 1 to FIG. 6, those inconveniences of the comparative example can all be resolved.

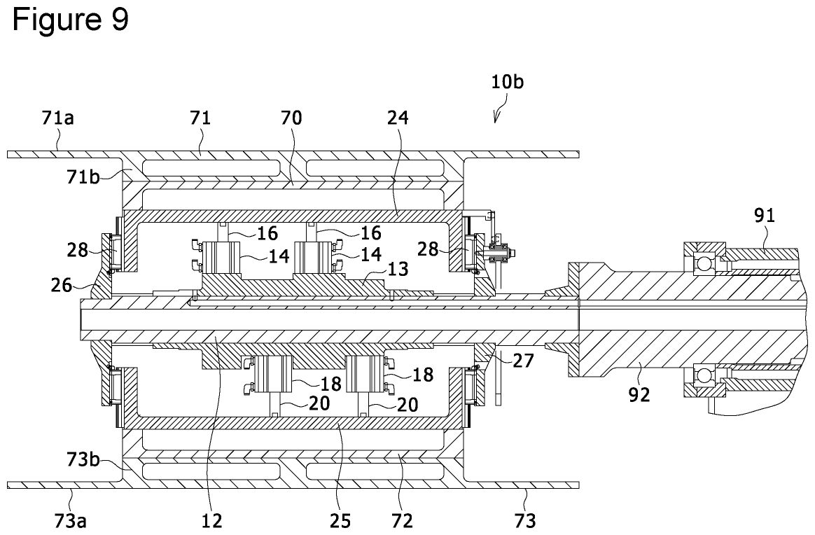

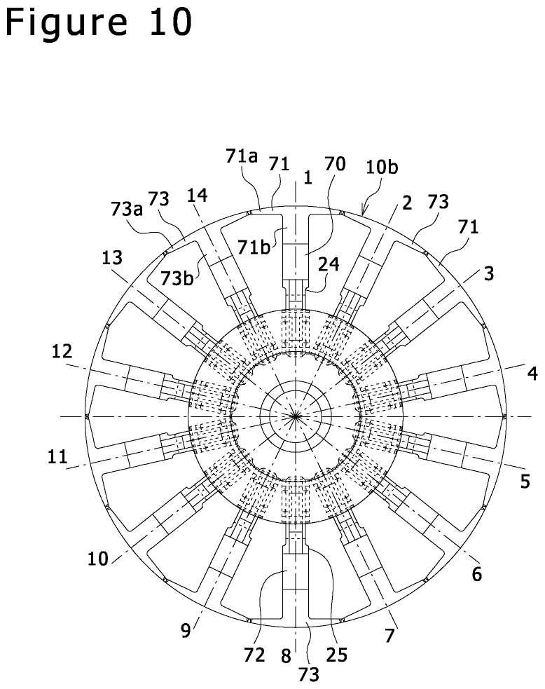

FIG. 9 is a longitudinal sectional view showing a diameter-expanded state of all segments in a band-forming drum 10b of another example of the embodiment. FIG. 10 is a view of the band-forming drum 10b seen from the distal end side. In the configuration of this example, the first joining members 24 each having a substantially U-shaped section are fixed to the distal ends of the first movable portions 16 that are disposed at a plurality of positions in the circumferential direction on the outer diameter side of the drum shaft 12 and that are movable in the radial direction. First segments 71 are fixed to the distal end surfaces of the first joining members 24 via first intermediate members 70 each having a substantially U-shaped section. Each of the first segments 71 has a leg portion 71b on the radial-direction inner side of a plate portion 71a, and has a substantially T-shaped section. The plate portion 71a is long in the axial direction of the drum shaft 12 and has an arc-shaped section, and the width of the leg portion 71b in the circumferential direction is small. The outer periphery of the first segment 71 is a curved surface having a substantially arc-shaped section. The first intermediate member 70 is fixed onto a distal end surface of the first joining member 24 by screw joining and the like. The first segment 71 is fixed onto a distal end surface of the first intermediate member 70 by screw joining and the like.

The second joining members 25 each having a substantially U-shaped section are fixed to the distal ends of the second movable portions 20 that are disposed at a plurality of positions in the circumferential direction on the outer diameter side of the drum shaft 12 and that are movable in the radial direction. Second segments 73 are fixed to the distal end surfaces of the second joining members 25 via second intermediate members 72 each having a substantially U-shaped section. Each of the second segments 73 has a leg portion 73b on the radial-direction inner side of a plate portion 73a, and has a substantially T-shaped section. The plate portion 73a is long in the axial direction of the drum shaft 12 and has an arc-shaped section, and the width of the leg portion 73b in the circumferential direction is small. The outer periphery of the second segment 73 is a curved surface having a substantially arc-shaped section. The second intermediate member 72 is fixed onto a distal end surface of the second joining member 25 by screw joining and the like. The second segment 73 is fixed onto a distal end surface of the second intermediate member 72 by screw joining and the like.

According to the configuration of this example, the intermediate members 70, 72 are provided between the joining members 24, 25 and the segments 71, 73, respectively, and the segments 71, 73 have substantially T-shaped sections having the leg portions 71b, 73b on the inner side of the plate portions 71a, 73a, respectively. As a result, the radial-direction length of the distal ends of the joining members 24, 25 and the outer peripheries of the segments 71, 73 can be made greater as compared to the embodiment in FIG. 1 to FIG. 6. As a result, the configuration of this example is more effective when the diameter of a tire including the band is large. In this example, other configurations and actions are similar to the configurations in FIG. 1 to FIG. 6.

In the configuration of each example of the embodiment described above, the number of the air cylinder(s) for each of the segments in the axial direction is not limited to two and may be one or a plurality of three or more. Meanwhile, the number of the air cylinder(s) for each of the segments in the axial direction is preferably two or more, in terms of easily holding each segment in the diameter-expanded state even when an external force is applied to the drum main body in a direction of reducing the diameter in the diameter-expanded state.

The present disclosure is further described by embodiments below.

### Configuration 1:

A band-forming drum configured to form the cylindrical band on the outer peripheral surface, the band-forming drum including:
the first segment connected to each of the plurality of first air cylinders arrayed in the circumferential direction, the plurality of first air cylinders each having the first movable portion movable in the radial direction of the band-forming drum; and
the second segment connected to each of the plurality of second air cylinders arrayed in the circumferential direction, the plurality of second air cylinders each having the second movable portion movable in the radial direction of the band-forming drum in a position different from each of the first air cylinders in the circumferential direction, wherein the plurality of first segments and the plurality of second segments do not face each other in the radial direction in a fully open state in which each of the plurality of first segments and the plurality of second segments is expanded in diameter.

### Configuration 2:

The band-forming drum according to configuration 1, wherein the stroke of the second air cylinder is longer than the stroke of the first air cylinder by 10 mm.

### Configuration 3:

The band-forming drum according to configuration 1 or 2, wherein the first segment and the second segment are equal in width corresponding to the axial direction of the band-forming drum.

### Configuration 4:

The band-forming drum according to any one of configurations 1 to 3, wherein: the plurality of first air cylinders spaced apart from each other in the axial direction of the band-forming drum are connected to each of the plurality of first segments as the first air cylinders; and
the plurality of second air cylinders spaced apart from each other in the axial direction of the band-forming drum are connected to each of the plurality of second segments as the second air cylinders.

### Configuration 5:

The band-forming drum according to any one of configuration 1 to 4, wherein one first air supply control valve configured to control supply of air for the plurality of first air cylinders and one second air supply control valve configured to control supply of air for the plurality of second air cylinders are provided.

### Configuration 6:

A control system of a band-forming drum, including:
the band-forming drum according to configuration 5; and
the control apparatus configured to control the first air supply control valve and the second air supply control valve.

### Configuration 7:

The control system of a band-forming drum according to configuration 6, wherein the control apparatus is configured to control the first air supply control valve and the second air supply control valve so as to place the plurality of first segments and the plurality of second segments in a diameter-expanded state and then change the plurality of second segments to a diameter-reduced state while maintaining the plurality of first segments in a diameter-expanded state, return the plurality of first segments and the plurality of second segments to a diameter-expanded state and then change the plurality of first segments to a diameter-reduced state while maintaining the plurality of second segments in a diameter-expanded state, and change the plurality of first segments and the plurality of second segments to a diameter-reduced state.

What is claimed is:

1. A band-forming drum configured to form a cylindrical band on an outer peripheral surface, the band-forming drum comprising:
a first segment connected to each of a plurality of first air cylinders arrayed in a circumferential direction, the plurality of first air cylinders each having a first movable portion movable in a radial direction; and
a second segment connected to each of a plurality of second air cylinders arrayed in the circumferential direction, the plurality of second air cylinders each having a second movable portion movable in the radial direction at a position different from each of the first air cylinders in the circumferential direction, wherein
a plurality of the first segments and a plurality of the second segments are alternately disposed in the circumferential direction such that the plurality of first segments and the plurality of second segments are in a same radial position and each of the plurality of first segments and each of the plurality of second segments are adjacent to each other with a gap interposed between the first segment and the second segment in the circumferential direction in a fully open state in which each of the plurality of first segments and the plurality of second segments are expanded in diameter.

2. The band-forming drum according to claim 1, wherein a stroke of the second air cylinder is longer than a stroke of the first air cylinder by 10 mm.

3. The band-forming drum according to claim 1, wherein the first segment and the second segment are equal in width corresponding to an axial direction of the band-forming drum.

4. The band-forming drum according to claim 1, wherein:
a plurality of the first air cylinders spaced apart from each other in an axial direction of the band-forming drum are connected to each of the plurality of first segments as the first air cylinders; and
a plurality of the second air cylinders spaced apart from each other in the axial direction of the band-forming drum are connected to each of the plurality of second segments as the second air cylinders.

5. The band-forming drum according to claim 1, wherein one first air supply control valve configured to control supply of air for the plurality of first air cylinders and one second air supply control valve configured to control supply of air for the plurality of second air cylinders are provided.

6. A control system of a band-forming drum, comprising:
the band-forming drum according to claim 5; and
a control apparatus configured to control the first air supply control valve and the second air supply control valve.

7. The control system of a band-forming drum according to claim 6, wherein the control apparatus is configured to control the first air supply control valve and the second air supply control valve so as to place the plurality of first segments and the plurality of second segments in a diameter-expanded state and then change the plurality of second segments to a diameter-reduced state while maintaining the plurality of first segments in a diameter-expanded state, return the plurality of first segments and the plurality of second segments to a diameter-expanded state and then change the plurality of first segments to a diameter-reduced state while maintaining the plurality of second segments in a diameter-expanded state, and change the plurality of first segments and the plurality of second segments to a diameter-reduced state.

8. A band-forming drum configured to form a cylindrical band on an outer peripheral surface, the band-forming drum comprising:
a first segment connected to each of a plurality of first air cylinders arrayed in a circumferential direction, the plurality of first air cylinders each having a first movable portion movable in a radial direction; and
a second segment connected to each of a plurality of second air cylinders arrayed in the circumferential direction, the plurality of second air cylinders each having a second movable portion movable in the radial direction at a position different from each of the first air cylinders in the circumferential direction, wherein
the plurality of the first segments and the plurality of the second segments do not face each other in the radial direction in a fully open state in which each of the plurality of first segments and the plurality of second segments is expanded in diameter.
